(19) United States
(12) Patent Application Publication
(10) Pub. No.: US 2024/0175475 A1
(43) Pub. Date: May 30, 2024

(54) THIN-WALLED TUBE FILLED WITH METAMATERIALS HAVING MIXED POISSON RATIOS

(71) Applicant: SOUTHWEST JIAOTONG UNIVERSITY, CHENGDU CITY (CN)

(72) Inventors: HU LIU, CHENGDU CITY (CN); GUOZHENG KANG, CHENGDU CITY (CN); QIANHUA KAN, CHENGDU CITY (CN); LEI YUE, CHENGDU CITY (CN)

(73) Assignee: SOUTHWEST JIAOTONG UNIVERSITY, CHENGDU CITY (CN)

(21) Appl. No.: 18/309,331

(22) Filed: Apr. 28, 2023

(30) Foreign Application Priority Data
Nov. 25, 2022 (CN) 202211491158.4

(51) Int. Cl. F16F 7/12

(52) U.S. Cl. CPC F16F 7/121; F16F 7/128; F16F 2234/00

(57) ABSTRACT

The present disclosure provides a thin-walled tube filled with a mixed Poisson ratios, including at least one PPR filling strip, at least one NPR filling strip, and a thin-walled tube body with a porous structure, where each hole of the thin-walled tube body is filled with the PPR filling strip or the NPR filling strip; the PPR filling strip includes a plurality of PPR cells that are connected in sequence, and the PPR cells each are prepared from a PPR metamaterial; the NPR filling strip includes a plurality of NPR cells that are connected in sequence, and the NPR cells each are prepared from an NPR metamaterial. In the present disclosure, the thin-walled tube can simultaneously have a longer effective compression stroke of the NPR metamaterial and a higher compression force platform of the PPR metamaterial, thereby greatly improving the impact resistance and energy absorption capacity of the tube structure.

### CROSS REFERENCE TO RELATED APPLICATION

This patent application claims the benefit and priority of Chinese Patent Application No. 202211491158.4 filed with the China National Intellectual Property Administration on Nov. 25, 2022, the disclosure of which is incorporated by reference herein in its entirety as part of the present application.

### TECHNICAL FIELD

The present disclosure relates to the technical field of structural impact and energy absorption, and in particular to a thin-walled tube filled with metamaterials having mixed Poisson ratios (MPR).

### BACKGROUND

With a desirable energy absorption capacity based on plastic deformation, thin-walled tube structures are generally used in anti-collision fields such as automobile bumpers. In recent years, numerous studies have shown that thin-walled tube structures filled with porous materials can have improved crashworthiness and energy absorption capacity. Under the action of impact load, the filler inside a filled tube can have coupling interaction with the tube wall, further changing a deformation mode of the tube, such that the structure may better absorb impact energy. Commonly used filling materials include foam and lightweight metamaterials. Compared with the traditional foam-filled tube structure, the metamaterial-filled tube structure not only exhibits an excellent performance in terms of energy absorption efficiency, but also has a lower weight and a higher strength. However, the existing metamaterial-filled tube structures adopt single-configuration metamaterials, most of which have positive or zero Poisson ratio structures. This design has a shorter effective stroke, which may affect the energy absorption capacity.

### SUMMARY

In view of the above problems, the present disclosure aims to provide a thin-walled tube filled with metamaterials having mixed Poisson ratios. In the present disclosure, via a coupling effect of a Positive Poisson ratio material and a Negative Poisson ratio material, an overall tube structure can have improved impact resistance and energy absorption capacity.

Technical solutions of the present disclosure are as follows:

The present disclosure provides a thin-walled tube filled with metamaterials having mixed Poisson ratios, including at least one positive Poisson ratio (PPR) filling strip, at least one negative Poisson ratio (NPR) filling strip, and a thin-walled tube body with a porous structure, wherein each hole of the thin-walled tube body is filled with the PPR filling strip or the NPR filling strip; the PPR filling strip includes a plurality of PPR cells that are connected in sequence, and the PPR cells each are prepared from a PPR metamaterial; the NPR filling strip includes a plurality of NPR cells that are connected in sequence, and the NPR cells each are prepared from an NPR metamaterial.

Preferably, the thin-walled tube body has a 3×3 structure.

Preferably, the at least one PPR filling strips comprises six PPR filling strips, and the at least one NPR filling strip comprises three NPR filling strips; three of the six PPR filling strips are filled in three holes in a first row of the thin-walled tube body, and another three of the six PPR filling strips are filled in three holes in a third row of the thin-walled tube body; and the three NPR filling strips are filled in three holes in a second row of the thin-walled tube body.

Preferably, the at least one PPR filling strip comprises three PPR filling strips, and the at least one NPR filling strip comprises six NPR filling strips; three of the six NPR filling strips are filled in three holes in a first row of the thin-walled tube body, and another three of the six NPR filling strips are filled in three holes in a third row of the thin-walled tube body; and the three PPR filling strips are filled in three holes in a second row of the thin-walled tube body.

Preferably, the at least one PPR filling strip comprises four PPR filling strips, and the at least one NPR filling strip comprises five NPR filling strips; the five NPR filling strips are filled in five diagonal holes of the thin-walled tube body, and the four PPR filling strips are filled in remaining four holes of the thin-walled tube body.

Preferably, the at least one PPR filling strip comprises five PPR filling strips, and the at least one NPR filling strip comprises four NPR filling strips; the five PPR filling strips are filled in five diagonal holes of the thin-walled tube body, and the four NPR filling strips are filled in remaining four holes of the thin-walled tube body.

Preferably, the at least one PPR filling strip comprises eight PPR filling strips, and the at least one NPR filling strip comprises one NPR filling strip; the one NPR filling strip is filled in a central hole of the thin-walled tube body, and the eight PPR filling strips are filled in remaining eight holes of the thin-walled tube body.

Preferably, the at least one NPR filling strip comprises eight NPR filling strips, and the at least one PPR filling strip comprises one PPR filling strip; the one PPR filling strip is filled in a central hole of the thin-walled tube body, and the eight NPR filling strips are filled in remaining eight holes of the thin-walled tube body.

The present disclosure has the following beneficial effects:

In the present disclosure, a thin-walled tube body is filled with a PPR metamaterial and an NPR metamaterial at the same time. The thin-walled tube can reasonably exert the advantages of the PPR metamaterial, having strong load resistance, a high platform force, a PPR effect, and strong interaction with a tube wall structure; the thin-walled tube can also reasonably exert the advantages of the NPR metamaterial, having a longer effective compression stroke and high impact energy absorption, thereby increasing a utilization rate of the metamaterial. Via a coupling effect of the PPR material and the NPR material, an overall tube structure can have improved impact resistance and energy absorption capacity.

### BRIEF DESCRIPTION OF THE DRAWINGS

In order to more clearly describe a technical solution in the embodiments of the present disclosure or in the prior art, a brief introduction to the accompanying drawings required for the description of the embodiments or the prior art will be provided below. Obviously, the accompanying drawings in the following description are merely some embodiments of the present disclosure. Those of ordinary skill in the art would also to derive other accompanying drawings from these accompanying drawings without making inventive efforts.

FIGS. 1A-1B and FIGS. 2A-2B show structural schematic diagrams of specific examples of PPR filling strips in the present disclosure; wherein FIG. 1A and FIG. 2A are schematic diagrams of overall structures of the PPR filling strips, and FIG. 1B and FIG. 2B are structural schematic diagrams of PPR cells;

FIGS. 3A-3B and FIGS. 4A-4B show structural schematic diagrams of specific examples of NPR filling strips in the present disclosure; wherein FIG. 3A and FIG. 4A are schematic diagrams of overall structures of the NPR filling strips, and FIG. 3B and FIG. 4B are structural schematic diagrams of NPR cells;

FIGS. 5A-5C, FIGS. 6A-6C, FIGS. 7A-7C, FIGS. 8A-8C, FIGS. 9A-9C and FIGS. 10A-10C show schematic diagrams of position distributions of the PPR filling strips and the NPR filling strips in a 3×3 thin-walled tube; wherein FIG. 5A, FIG. 6A, FIG. 7A, FIG. 8A, FIG. 9A and FIG. 10A are schematic diagrams of three-dimensional structures of the thin-walled tubes filled with metamaterials having mixed Poisson ratios of the present disclosure; FIG. 5B, FIG. 6B, FIG. 7B, FIG. 8B, FIG. 9B and FIG. 10B are schematic diagrams of top view structures of the thin-walled tubes filled with metamaterials having mixed Poisson ratios of the present disclosure; and FIG. 5C, FIG. 6C, FIG. 7C, FIG. 8C, FIG. 9C and FIG. 10C are schematic diagrams of filling positions of filling strips;

FIG. 11 shows a comparative schematic diagram of an impact compression force-displacement curve of the thin-walled tube filled with metamaterials having mixed Poisson ratios of the present disclosure and a thin-walled tube only filled with a PPR or NPR metamaterial of the prior art; and

FIG. 12 shows a comparative schematic diagram of an absorbed impact energy-displacement curve of the thin-walled tube filled with metamaterials having mixed Poisson ratios of the present disclosure and the thin-walled tube only filled with a PPR or NPR metamaterial of the prior art.

### DETAILED DESCRIPTION OF THE EMBODIMENTS

The present disclosure will be further described below in conjunction with the accompanying drawings and embodiments. It should be noted that the embodiments in the present disclosure and features in the embodiments may be combined with each other in a non-conflicting situation. Unless otherwise specified, it should be noted that all technical and scientific terms used herein have the same meaning as commonly understood by one of ordinary skill in the technical field to which the present disclosure belongs. “Comprising”, “including” and similar words used in the present disclosure mean that an element or article appearing before the term includes elements or articles and their equivalent elements appearing behind the term, not excluding any other elements or articles.

The present disclosure provides a thin-walled tube filled with metamaterials having mixed Poisson ratios, including at least one PPR filling strip, at least one NPR filling strip, and a thin-walled tube body with a porous structure, wherein each hole of the thin-walled tube body is filled with the PPR filling strip or the NPR filling strip; the PPR filling strip is formed with a plurality of PPR cells that are connected in sequence, and the PPR cells each are prepared from a PPR metamaterial; the NPR filling strip is formed with a plurality of NPR cells that are connected in sequence, and the NPR cells each are prepared from an NPR metamaterial.

In the above embodiment, by simultaneously filling the PPR filling strips prepared from the PPR metamaterial and the NPR filling strips prepared from the NPR metamaterial, the thin-walled tube structure filled with the MPR metamaterials can have the advantages of both the thin-walled tube filled with only the PPR metamaterial and the thin-walled tube filled with only the NPR metamaterial at the same time, thereby improving the impact resistance capacity and impact energy absorption effect of the overall tube structure.

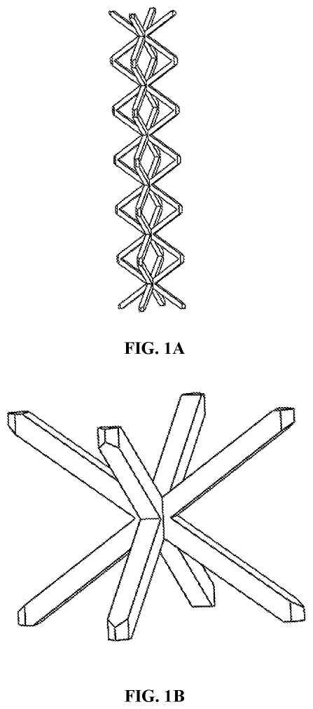

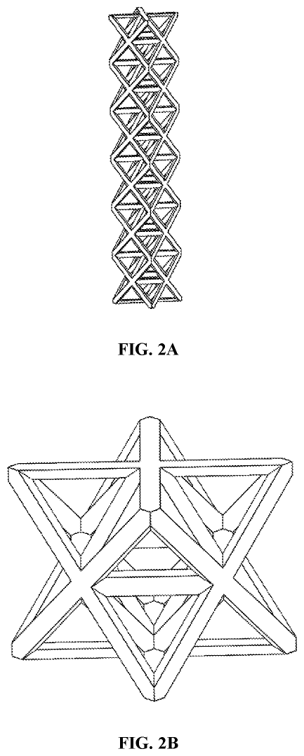

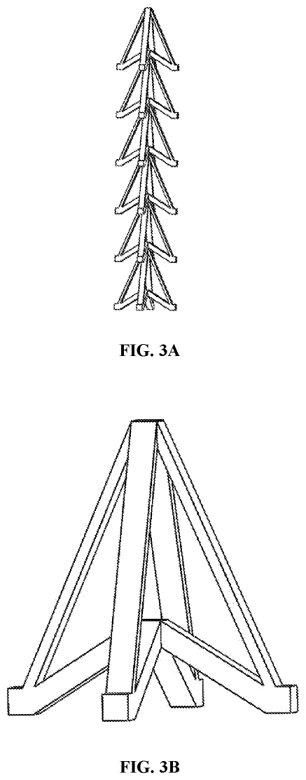

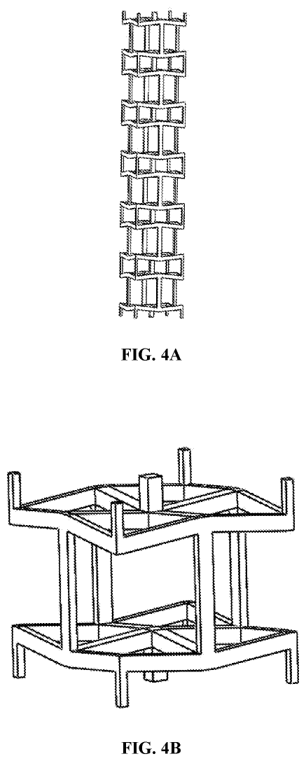

In a specific example, the PPR filling strip is shown in FIGS. 1A-1B or FIGS. 2A-2B, and the NPR filling strip is shown in FIGS. 3A-3B or FIGS. 4A-4B.

In a specific example, the thin-walled tube body has a 3×3 structure.

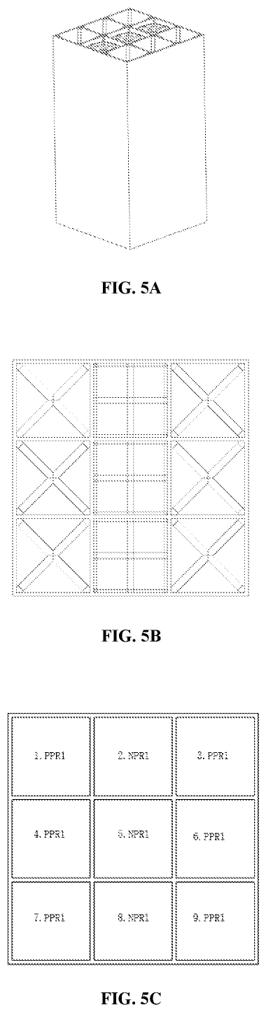

Optionally, as shown in FIGS. 5A-5C, six PPR filling strips are provided, and three NPR filling strips are provided, wherein three of the PPR filling strips are filled in three holes in a first row of the thin-walled tube body, and the other three of the PPR filling strips are filled in three holes in a third row of the thin-walled tube body; and the three NPR filling strips are filled in three holes in a second row of the thin-walled tube body.

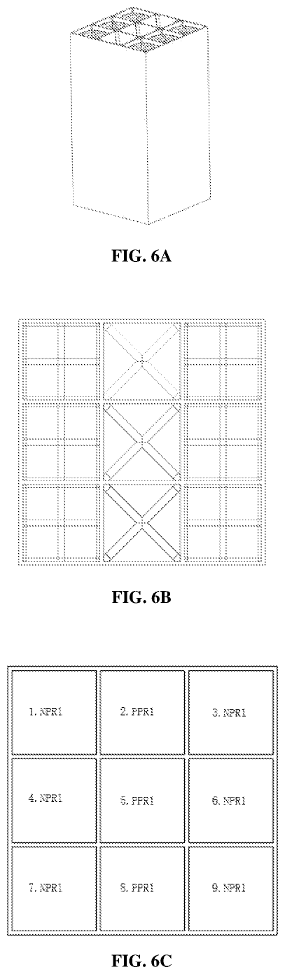

Optionally, as shown in FIGS. 6A-6C, three PPR filling strips are provided, and six NPR filling strips are provided, wherein three of the NPR filling strips are filled in three holes in a first row of the thin-walled tube body, and the other three of the NPR filling strips are filled in three holes in a third row of the thin-walled tube body; and the three PPR filling strips are filled in three holes in a second row of the thin-walled tube body.

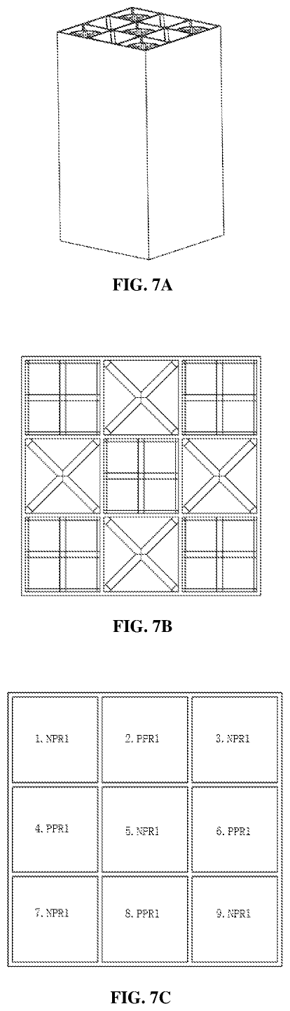

Optionally, as shown in FIGS. 7A-7C, four PPR filling strips are provided, and five NPR filling strips are provided, wherein the five NPR filling strips are filled in five diagonal holes of the thin-walled tube body, and the four PPR filling strips are filled in remaining four holes of the thin-walled tube body.

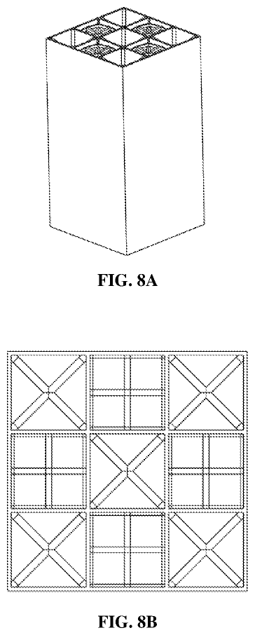

Optionally, as shown in FIGS. 8A-8C, five PPR filling strips are provided, and four NPR filling strips are provided, wherein the five PPR filling strips are filled in five diagonal holes of the thin-walled tube body, and the four NPR filling strips are filled in remaining four holes of the thin-walled tube body.

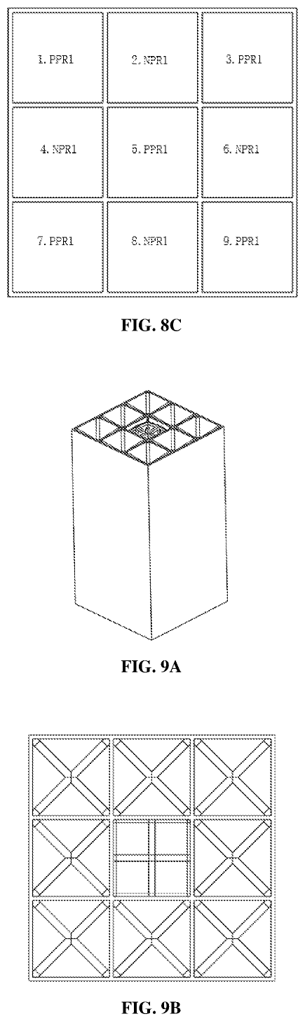

Optionally, as shown in FIGS. 9A-9C, eight PPR filling strips are provided, and one NPR filling strips is provided, wherein the one NPR filling strip is filled in a central hole of the thin-walled tube body, and the eight PPR filling strips are filled in remaining eight holes of the thin-walled tube body.

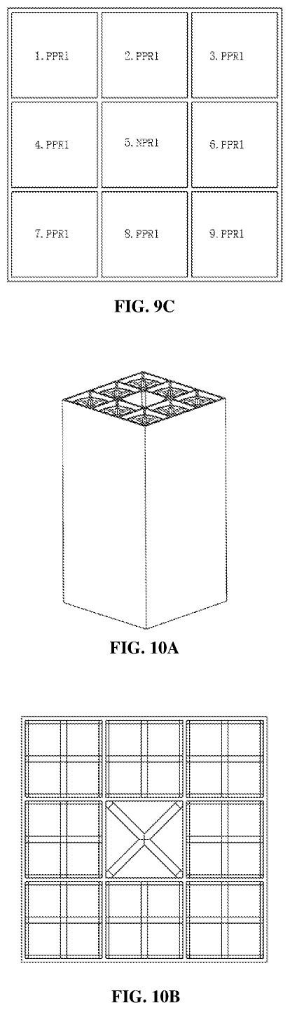

Optionally, as shown in FIGS. 10A-10C, eight NPR filling strips are provided, and one PPR filling strips is provided, wherein the one PPR filling strip is filled in a central hole of the thin-walled tube body, and the eight NPR filling strips are filled in remaining eight holes of the thin-walled tube body.

It should be noted that the above-mentioned examples are only the preferred distribution modes of the NPR filling strips and the PPR filling strips of the present disclosure, which can make the coupling effect of the NPR and PPR metamaterials more uniform. When using the present disclosure, other distribution modes can also be used for filling according to different needs such as energy absorption points. For example, for the same 3×3 thin-walled tube, one NPR filling strip is filled in the hole in the first column and first row of the thin-walled tube body, while the remaining eight holes are filled with the PPR filling strips.

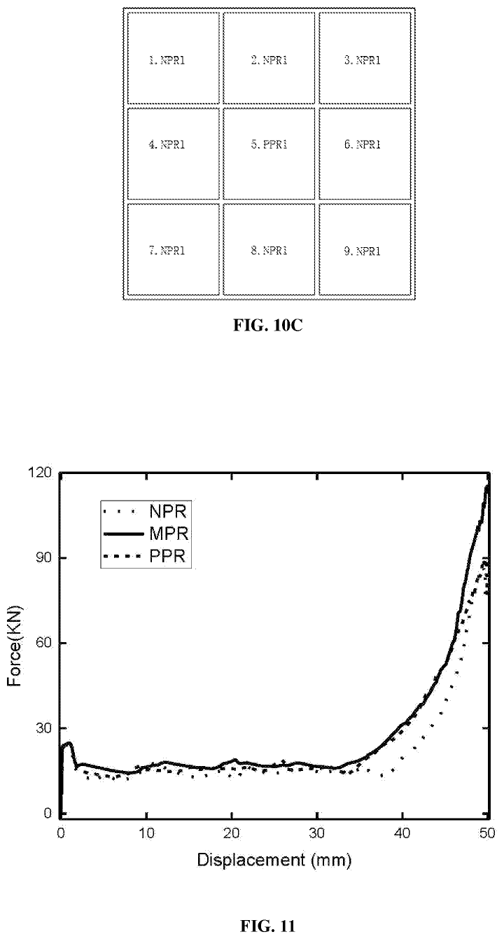

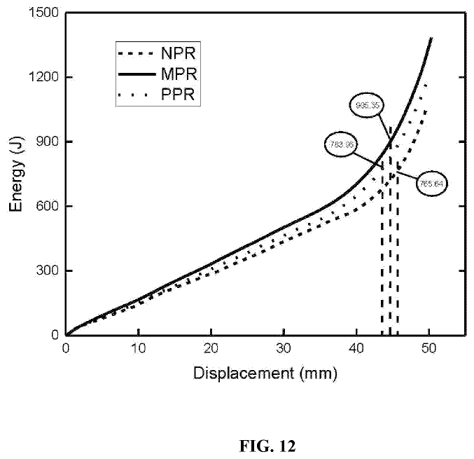

In a specific example, the performance comparison results of the thin-walled tube filled with an MPR metamaterial and a conventional thin-walled tube only filled with a PPR metamaterial or NPR metamaterial are shown in FIG. 11, FIG. 12, and Table 1:

TABLE 1
Performances of thin-walled tube filled with a metamaterial

| Filling | Average platform | Maximum compression | Absorbed impact |
|---|---|---|---|
| material | force, KN | displacement, mm | energy, J |
| PPR | 15.82 | 43.79 | 783.96 |
| NPR | 14.21 | 45.63 | 765.64 |
| MPR | 17.87 | 44.67 | 905.35 |

From FIG. 11, FIG. 12, and Table 1, it can be seen that compared with the thin-walled tube only filled with a PPR or NPR metamaterial in the prior art, the thin-walled tube filled with an MPR metamaterial had an average platform force increased by 12.96% and 25.76%, respectively, a maximum compression displacement being not much different with an error of 2.01% and 2.10%, respectively, and absorbed impact energy increased by 15.48% and 18.25%, respectively. As shown above, compared with the prior art, the performances of the thin-walled tube filled with an MPR metamaterial were significantly enhanced.

In this example, when only the PPR metamaterial was used to fill the thin-walled tube structure, since the PPR metamaterial had a PPR effect and a high platform force in a lateral direction when being impacted and compressed, the metamaterial was always in close contact with the tube wall of the thin-walled tube structure during the impact compression. The metamaterial and the thin-walled tube are interacted to each other strongly, resulting in a better energy effect of the overall structure. However, compared with the NPR metamaterial, the PPR metamaterial had an unsatisfactory effect of absorbing energy during impact compression, and the metamaterial was not fully utilized, resulting in a low utilization rate.

When the thin-walled tube structure was filled with the NPR metamaterial only, since the NPR metamaterial had a cohesive effect in the lateral direction when being impacted and compressed, and the effective compression stroke was longer, such that the NPR metamaterial could absorb more impact energy. However, when the thin-walled tube was compressed and impacted, it deformed laterally outward, and the NPR metamaterial deformed cohesively in the lateral direction. During the impact compression, there was a gap between the metamaterial and the thin-walled tube, which reduced the interaction a lot, thus making the impact energy absorption effect of the overall structure lower than that of the thin-walled tube structure filled with the PPR metamaterial.

However, in the present disclosure, when filling the thin-walled tube with the PPR metamaterial and the NPR metamaterial simultaneously, the thin-walled tube structure filled with the metamaterials could have the advantages of the thin-walled tube only filled with the PPR metamaterial and the thin-walled tube only filled with the NPR metamaterial at the same time, thereby improving the impact resistance capacity and impact energy absorption effect of the overall tube structure.

In conclusion, in the present disclosure, via a coupling effect of a PPR material and an NPR material, an overall tube structure can have improved impact resistance and energy absorption capacity, thus avoiding the shorter effective stroke and insufficient energy absorption capacity of the existing metamaterial-filled tube structure. Compared with the prior art, the present disclosure represents a significant improvement.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. A thin-walled tube filled with metamaterials having mixed Poisson ratios, comprising at least one positive Poisson ratio (PPR) filling strip, at least one negative Poisson ratio (NPR) filling strip, and a thin-walled tube body with a porous structure, wherein each hole of the thin-walled tube body is filled with the PPR filling strip or the NPR filling strip; the PPR filling strip comprises a plurality of PPR cells that are connected in sequence, and the PPR cells each are prepared from a PPR metamaterial; the NPR filling strip comprises a plurality of NPR cells that are connected in sequence, and the NPR cells each are prepared from an NPR metamaterial.

2. The thin-walled tube filled with metamaterials having mixed Poisson ratios according to claim 1, wherein the thin-walled tube body has a 3×3 structure.

3. The thin-walled tube filled with metamaterials having mixed Poisson ratios according to claim 2, wherein the at least one PPR filling strip comprises six PPR filling strips, and the at least one NPR filling strip comprises three NPR filling strips; three of the six PPR filling strips are filled in three holes in a first row of the thin-walled tube body, and another three of the six PPR filling strips are filled in three holes in a third row of the thin-walled tube body; and the three NPR filling strips are filled in three holes in a second row of the thin-walled tube body.

4. The thin-walled tube filled with metamaterials having mixed Poisson ratios according to claim 2, wherein the at least one PPR filling strip comprises three PPR filling strips, and the at least one NPR filling strip comprises six NPR filling strips; three of the six NPR filling strips are filled in three holes in a first row of the thin-walled tube body, and another three of the six NPR filling strips are filled in three holes in a third row of the thin-walled tube body; and the three PPR filling strips are filled in three holes in a second row of the thin-walled tube body.

5. The thin-walled tube filled with metamaterials having mixed Poisson ratios according to claim 2, wherein the at least one PPR filling strip comprises four PPR filling strips, and the at least one NPR filling strip comprises five NPR filling strips; the five NPR filling strips are filled in five diagonal holes of the thin-walled tube body, and the four PPR filling strips are filled in remaining four holes of the thin-walled tube body.

6. The thin-walled tube filled with metamaterials having mixed Poisson ratios according to claim 2, wherein the at least one PPR filling strip comprises five PPR filling strips, and the at least one NPR filling strip comprises four NPR filling strips; the five PPR filling strips are filled in five diagonal holes of the thin-walled tube body, and the four NPR filling strips are filled in remaining four holes of the thin-walled tube body.

7. The thin-walled tube filled with metamaterials having mixed Poisson ratios according to claim 2, wherein the at least one PPR filling strips comprises eight PPR filling strips, and the at least one NPR filling strip comprises one NPR filling strip; the one NPR filling strip is filled in a central hole of the thin-walled tube body, and the eight PPR filling strips are filled in remaining eight holes of the thin-walled tube body.

8. The thin-walled tube filled with metamaterials having mixed Poisson ratios according to claim 2, wherein the at least one NPR filling strip comprises eight NPR filling strips, and the at least one PPR filling strip comprises one PPR filling strip; the one PPR filling strip is filled in a central hole of the thin-walled tube body, and the eight NPR filling strips are filled in remaining eight holes of the thin-walled tube body.
